(19) United States
(12) Patent Application Publication
(10) Pub. No.: US 2019/0004408 A1
(43) Pub. Date: Jan. 3, 2019

(54) OPTICAL MIXER AND MULTI-WAVELENGTH HOMOGENEOUS LIGHT SOURCE USING THE SAME

(71) Applicant: Hitachi Chemical Company, Ltd., Tokyo (JP)

(72) Inventors: Tomoto KAWAMURA, Tokyo (JP); Toshiteru NAKAMURA, Tokyo (JP); Seiji MURATA, Tokyo (JP); Yoshiho SEO, Tokyo (JP); Toshihiro KURODA, Tokyo (JP); Yutaka KAWAKAMI, Tokyo (JP); Daichi SAKAI, Tokyo (JP); Toshiyuki TAKAIWA, Tokyo (JP)

(21) Appl. No.: 15/781,157

(22) PCT Filed: Feb. 2, 2017
(86) PCT No.: PCT/JP2017/003718

§ 371 Date: Jun. 4, 2018

(30) Foreign Application Priority Data
Feb. 4, 2016 (JP) 2016-019412

(51) Int. Cl. G03B 21/20; H04N 9/31; F21V 8/00

(52) U.S. Cl. CPC G03B 21/208; G02B 6/0016; G03B 21/2066; H04N 9/3105

(57) ABSTRACT

An optical mixer efficiently homogenizes light flux emitted from a plurality of light sources emitting light having different wavelengths to provide a multi-wavelength homogeneous light source. The optical mixer has a columnar shape made of a transparent material, a length of the side surfaces is larger than an outermost diameter of a top surface or a bottom surface of the columnar shape, and a large number of scattering particles scattering light contained inside the optical mixer. The side surface of the optical mixer reflects light, and the top surface and the bottom surface thereof transmit light. Thereby, a function of mixing light incident from the top or bottom surface by the reflecting function of the side surface and the scattering function of the scattering particles is provided.

### TECHNICAL FIELD

The present invention relates to an optical mixer for uniformly mixing light and a multi-wavelength homogeneous light source using the same.

### BACKGROUND ART

Techniques for diffusing light have been proposed in Patent Documents 1, 2, and the like.

### CITATION LIST

### Patent Document

Patent Document 1: JP 2015-148730 A

Patent Document 2: JP 2007-67076 A

### SUMMARY OF THE INVENTION

### Problems to be Solved by the Invention

Generally, in a display device such as a projector or a liquid crystal television, light sources of three colors of red, green, and blue are used. For this reason, in a display device, light fluxes output from three different light sources are converted into homogeneous light fluxes and used.

In order to allow light beams from a plurality of light sources to be homogeneous, Patent Document 1 discloses a technology of arranging a diffusion layer in a far distance by using light fluxes emitted from a plurality of light sources, and Patent Document 2 discloses a technique of arranging a diffusion layer directly under the light sources by using the light beams from a plurality of light sources.

Since Patent Document 1 is the technology of an illumination device that illuminates a room, Patent Document 1 is unsuitable for downsizing. Since the diffusion layer is directly under the light source, Patent Document 2 is problematic in that the efficiency of the emitted light is low.

The invention is to provide an optical mixer capable of efficiently mixing and homogenizing light fluxes emitted from a plurality of light sources in a small size and a multi-wavelength homogeneous light source using the same.

### Solutions to Problems

The above object can be achieved, for example, by the invention described in the claims.

More specifically, the multi-wavelength homogeneous light source according to the invention includes: a multi-wavelength light source substrate having a plurality of light sources emitting light having different wavelengths; and an optical mixer mixing the light, wherein the optical mixer has a columnar shape made of a transparent material, and a length of a side surface is larger than an outermost diameter of a top surface or a bottom surface of the columnar shape, wherein a large number of scattering particles having a function of scattering light are contained inside the optical mixer, wherein the side surface of the optical mixer has a function of reflecting light, wherein the top surface and the bottom surface of the optical mixer have a function of transmitting light, wherein a function of mixing light incident from the top surface or the bottom surface by the reflecting function of the side surface and the scattering function of the scattering particles is provided, and wherein, in the multi-wavelength homogeneous light source, a surface where the plurality of light sources of the multi-wavelength light source substrate are arranged and the top surface or the bottom surface of the optical mixer are in close contact with each other.

### Effects of the Invention

It is possible to provide a multi-wavelength homogeneous light source capable of emitting homogeneous light having a plurality of wavelengths in a bright, compact, and inexpensive manner with low power consumption.

### BRIEF DESCRIPTION OF THE DRAWINGS

FIG. 1 is a schematic view illustrating a multi-wavelength homogeneous light source 1 (First Embodiment).

FIG. 2 is a schematic view illustrating a multi-wavelength light source substrate 2 (First Embodiment).

FIG. 3 is a result of calculation of distance dependency of a side surface in a case where scattering particles 9 of an optical mixer 6 are zero (First Embodiment).

FIG. 4 is a result of calculation of density dependency of the scattering particles 9 of the optical mixer 6 (First Embodiment).

FIG. 5 is a result of calculation of region characteristics of a region where the scattering particles 9 of the optical mixer 6 are arranged (First Embodiment).

FIG. 6 is a result of calculation of size dependency of the region where the scattering particles 9 of the optical mixer 6 are arranged (First Embodiment).

FIG. 7 is a system block diagram of the multi-wavelength homogeneous light source 1 (First Embodiment).

FIG. 8 is a view describing a first example of a method of manufacturing the multi-wavelength homogeneous light source 1 (Second Embodiment).

FIG. 9 is a view describing a second example of the method of manufacturing the multi-wavelength homogeneous light source 1 (Second Embodiment).

FIG. 10 is a view describing a third example of the method of manufacturing the multi-wavelength homogeneous light source 1 (Second Embodiment).

FIG. 11 is a view describing a fourth example of the method of manufacturing the multi-wavelength homogeneous light source 1 (Second Embodiment).

FIG. 12 is a view describing a fifth example of the method of manufacturing the multi-wavelength homogeneous light source 1 (Second Embodiment).

FIG. 13 is a schematic view illustrating a multi-wavelength homogeneous light source 31 (Third Embodiment).

FIG. 14 is a schematic view illustrating a multi-wavelength homogeneous light source 34 (Third Embodiment).

FIG. 15 is a schematic view illustrating a multi-wavelength homogeneous light source 36 (Third Embodiment).

FIG. 16 is a schematic view illustrating a multi-wavelength homogeneous light source 41 (Third Embodiment).

FIG. 17 is a schematic view illustrating a multi-wavelength homogeneous light source 44 (Third Embodiment).

FIG. 18 is a schematic view illustrating a multi-wavelength light source substrate 48 (Third Embodiment).

FIG. 19 is a schematic view illustrating a multi-wavelength light source substrate 50 (Third Embodiment).

FIG. 20 is a schematic view illustrating a multi-wavelength homogeneous light source 61 (Third Embodiment).

FIG. 21 is a schematic view illustrating an image projection device 70 (Fourth Embodiment).

FIG. 22 is a view describing an example of a method of manufacturing an illumination unit 73 (Fourth Embodiment).

FIG. 23 is a view describing an application example of the image projection device 70 (Fourth Embodiment).

FIG. 24 is a view describing an example of the optical mixer 6 (First Embodiment).

FIG. 25 is a schematic view illustrating a multi-wavelength homogeneous light source 201 (Fifth Embodiment).

### MODE FOR CARRYING OUT THE INVENTION

Hereinafter, modes for carrying out the invention will be described based on embodiments illustrated in the drawings, but the invention is not limited thereto. In the drawings, components having the same function are denoted by the same reference numeral.

### First Embodiment

A first embodiment of the invention will be described with reference to the drawings.

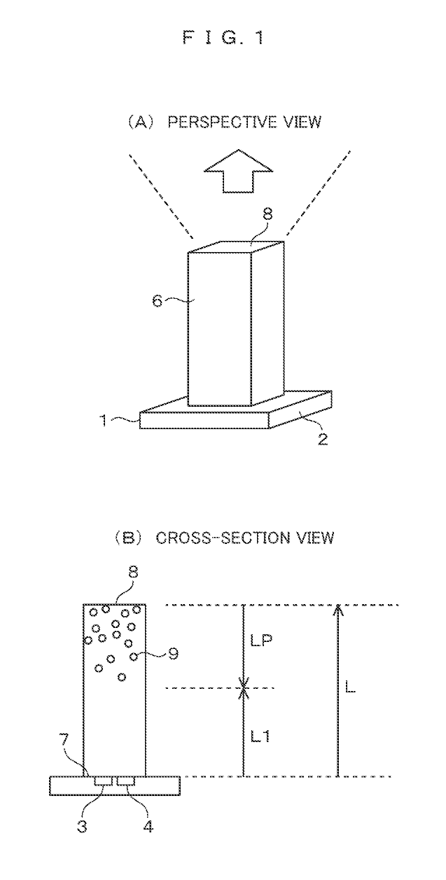

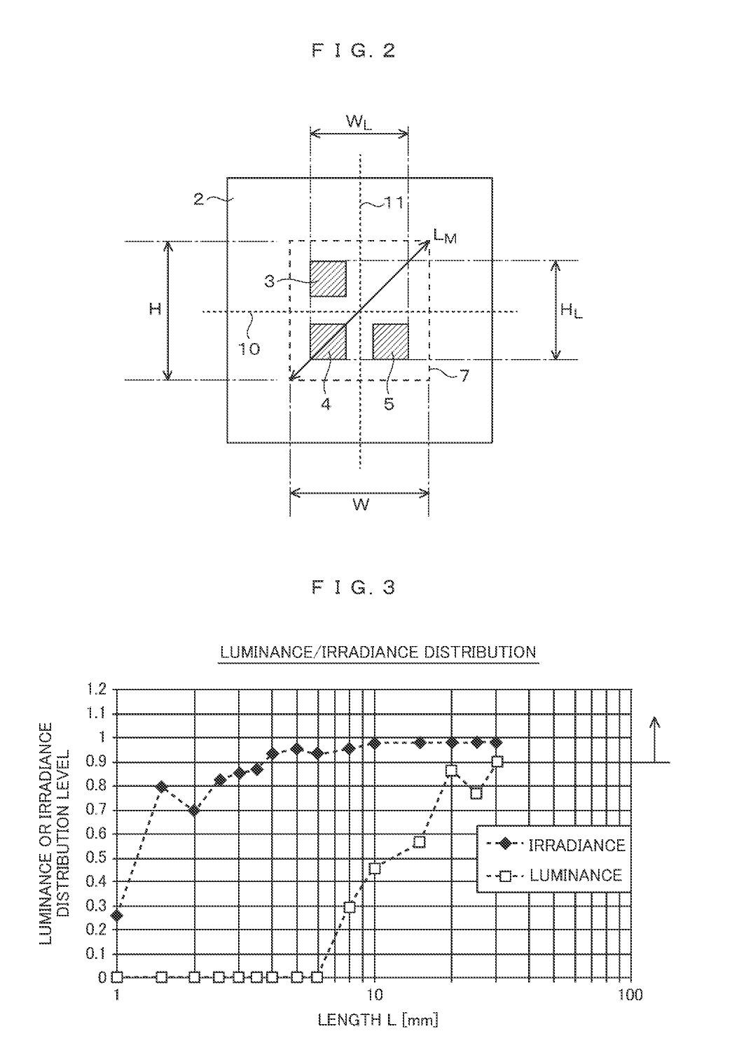

A multi-wavelength homogeneous light source 1 will be described with reference to FIGS. 1 and 2. FIG. 1 is a perspective view (A) and a cross-section view (B) of a multi-wavelength homogeneous light source 1 and FIG. 2 is a schematic view illustrating a multi-wavelength light source substrate 2.

As illustrated in FIG. 1, the multi-wavelength homogeneous light source 1 includes a multi-wavelength light source substrate 2 and an optical mixer 6.

The multi-wavelength light source substrate 2 is a light source substrate having at least a plurality of light sources. In the first embodiment, as illustrated in FIG. 2, the multi-wavelength light source substrate 2 includes three light sources of an R light source 3 that emits red light, a G light source 4 that emits green light and a B light source 5 that emits blue light. In addition, the broken lines 10 and 11 in FIG. 2 indicate the central axis of the multi-wavelength light source substrate 2.

The optical mixer 6 is a quadrangular prism having a length L made of a transparent material having a refractive index N1 and includes scattering particles 9 made of a transparent material having a refractive index N2 different from the refractive index N1.

The quadrangular prism may be made of any material as long as the material is transparent, and the material may be a glass or a resin. Since the prism contains minute scattering particles inside, the prism is easily manufactured by using the resin. In addition, if the surface of the quadrangular prism is rough, a light leakage efficiency is deteriorated. Therefore, it is preferable that the surface of the quadrangular prism is mirror-polished.

Generally, it is preferable that, in the light pipe, in order to mix the light, shapes of the incident surface and the light emitting surface have shapes of polygons which are arranged without gaps when a plurality of light pipes are developed.

It is preferable that, since the optical mixer 6 also uses the function of the inner surface reflection of the light pipe, the incident surface 7 and the light emitting surface 8 have shapes of polygons (a substantially equilateral triangle, a quadrangle, or a substantially regular hexagon) which are arranged without gaps when a plurality of light pipes are developed.

The scattering particles 9 need not be made of a transparent material, and any material having any shape may be used as long as the material has a function of scattering light. In order to realize the function of efficiently scattering the scattering particles 9, it is preferable to use transparent spheres as scattering particles. If the scattering particles are too smaller than the wavelength of the light source, the backscattering is increase, and thus, the efficiency is deteriorated. On the contrary, if the scattering particles are too large, the light travels without scattering. Therefore, in view of the Mie scattering theory, in a case where the incident light is visible light, the scattering particles are preferably transparent spherical particles and are slightly larger than the wavelength by 1 μm to 5 μm.

The optical mixer 6 is mounted in close contact with the multi-wavelength light source substrate 2. The light emitted from each light source of the multi-wavelength light source substrate 2 is incident on the incident surface 7 of the optical mixer, is mixed homogeneously inside the optical mixer, and is emitted from the light emitting surface 8 in the direction of the arrow in the drawing.

It is preferable that the multi-wavelength light source substrate 2 and the incident surface 7 are brought into close contact with each other within a possible range. By bringing the multi-wavelength light source substrate 2 and the incident surface 7 close to each other, it is possible to efficiently guide the light emitted from the light source of the multi-wavelength light source substrate 2 to the optical mixer 6. It is more preferable to be attached with a transparent adhesive having a refractive index similar to the refractive index N1 of the transparent material. By eliminating the air layer, the light emitted from the light source of the multi-wavelength light source substrate 2 can be most efficiently guided to the optical mixer 6.

The light incident on the optical mixer 6 is confined by inner surface reflection at the side surface of the transparent optical mixer 6 from the incident surface 7 to the distance L1. The light is mixed by repeating inner surface reflection. Furthermore, when the light travels by a distance L1 from the incident surface 7, the light is confined by inner surface reflection and mixed by inner surface reflection, but also the light scattered by the scattering particles which are transparent materials having a refractive index N2 are mixed. For this reason, the irradiance and the luminance having an angular component of the incident light are uniformly homogenized.

As illustrated in FIG. 2, the R light source 3, the G light source 4, and the B light source 5 of the multi-wavelength light source substrate 2 are arranged within the range of the WL and the height HL. It is preferable that the H and the height W of the incident surface 7 of the optical mixer 6 be larger than the WL and the height HL which are the range of each light source is provided as illustrated in the drawing. By setting in this manner, it is possible to efficiently guide the light emitted from each light source to the optical mixer 6 without loss of light.

If the W and the height H of the incident surface 7 of the optical mixer 6 are allowed to be larger than the WL and the height HL which are the range of the light source, the allowable amount of the error of installation of the multi-wavelength light source substrate 2 and the optical mixer 6 is increased. On the contrary, if the allowable amount of the error of installation is too large, the luminance to be emitted becomes small. This is a phenomenon based on the optical principle in which the luminance is inversely proportional to the area of the light emitting surface 8. That is, the W and the height H of the incident surface 7 of the optical mixer 6 are preferably set to be slightly larger than the WL and the height HL, which are the range of the light source, by taking into consideration only the error of installation.

As described above, the respective color light beams emitted from the R light source 3, the G light source 4, and the B light source 5 having different light emitting point positions of the multi-wavelength light source substrate 2 pass through the optical mixer 6, so that the light of which the irradiance and the luminance are homogenized are efficiently emitted from the optical mixer 6.

Next, the results of calculating the performance of the multi-wavelength homogeneous light source 1 using the optical mixer 6 will be described with reference to FIGS. 3 to 6.

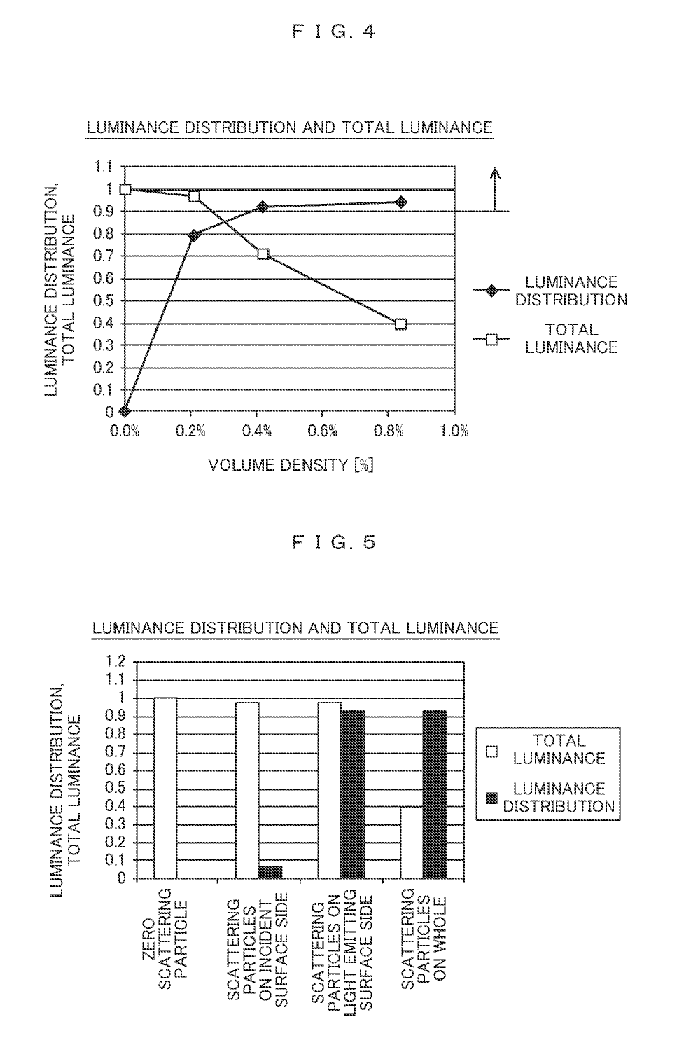

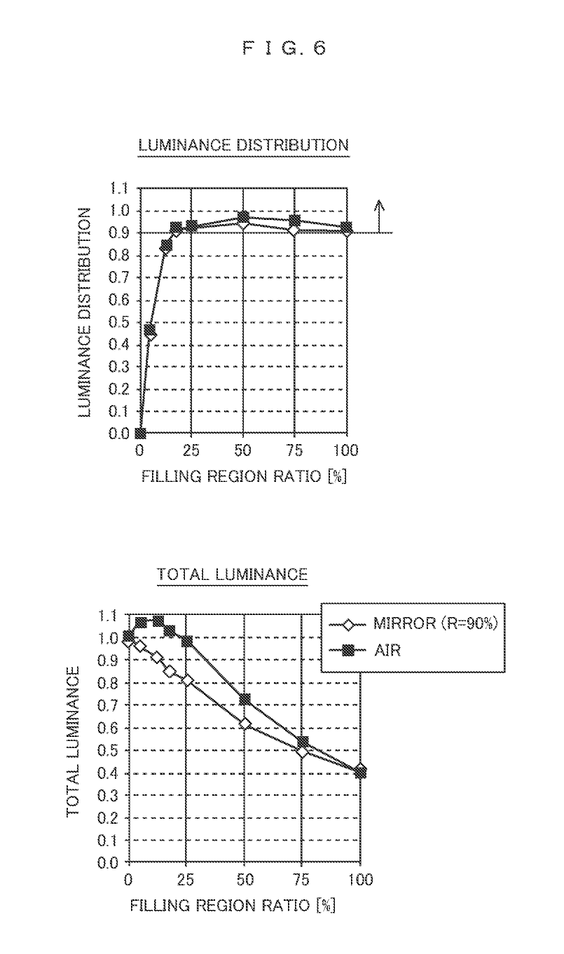

FIG. 3 illustrates a result of calculation of distance (L) dependency of the luminance/irradiance distribution of the light emitting surface 8 in the case of a transparent rod where the scattering particles 9 of the optical mixer 6 are assumed to be zero. FIG. 4 illustrates a result of calculation of density dependency of the scattering particles 9 of the optical mixer 6. FIG. 5 illustrates a result of calculation of region characteristics of a region where the scattering particles 9 of the optical mixer 6 are arranged. FIG. 6 illustrates a result of calculation of region dependency of the region where the scattering particles 9 of the optical mixer 6 are arranged.

Although the conditions of this calculation are described below, it is, of course, one example, and it is not necessary to be the same condition as the parameter of this calculation.

The optical mixer 6 has a shape of a square quadrangular prism with a piece of 1 mm, and the inside thereof is a transparent material having a refractive index of 1.58. The scattering particles 9 are spherical bodies having a diameter of 2 μm and are transparent materials having a refractive index of 1.48.

The light source was a square light emitting surface with a piece of 0.2 mm and was placed at a position offset 0.3 mm from the center axis. The light source is supposed to emit Lambasian light which is in a perfect diffusion. The light-receiving surface to be detected is arranged on the light emitting surface 8, the light emitting surface 8 is divided into 11×11, the amount of light incident on each region is taken as irradiance, and the amount of light within 20 degrees incident on each region is calculated as luminance.

First, length dependency of the irradiance and the luminance on the light emitting surface of the transparent rod when the scattering particles 9 are zero in the optical mixer 6 will be described with reference to FIG. 3. The horizontal axis in the figure represents a logarithmic length L of the optical mixer 6. The vertical axis represents irradiance or luminance distribution which is an index of homogenization. This index illustrates a ratio of the minimum value and the maximum value of the irradiance and the luminance of each region of the light emitting surface 8. When the index is 1, it means that the minimum value and the maximum value are consistent, and when the index exceeds 0.9, it can be determined that the light is substantially homogeneous. The black mark indicates irradiance, and the white mark indicates luminance.

It can be understood from the result of calculation that the irradiance and the luminance distribution are increased as the length L is increased and the distribution is improved, and when the irradiance distribution becomes 4 mm and the luminance distribution exceeds 30 mm, the light becomes homogeneous (exceeding 0.9 in the figure). This is because the incident light is mixed by inner surface reflection as described above. It is understood that a length of about 7.5 times is required to make the luminance homogeneous with respect to the irradiance.

In the invention, in order to homogenize both the irradiance distribution and the luminance distribution in a short distance, the light is mixed by using two optical principles of inner surface reflection on the side and scattering by scattering particles.

Since the length L of the optical mixer 6 is 4 mm and the irradiance is homogeneous, the calculations in FIGS. 4 to 6 are calculated by fixing the length L of the optical mixer 6 to 4 mm. In addition, since the irradiance is further improved in a case where filling with the scattering particles 9 is performed, the result of calculation is provided in the following drawings.

The result of changing the density of the scattering particles 9 when the entire optical mixer 6 is filled with the scattering particles 9 will be described with reference to FIG. 4.

In the figure, the horizontal axis represents the volume density of the scattering particles 9, and the vertical axis represents the luminance distribution and the total luminance at the time of reaching the light emitting surface 8. The total luminance is normalized on the basis of a case where the volume density of the scattering particles 9 is zero.

It can be understood from the figure that as the volume density is increased, the luminance distribution is improved, and the total luminance is decreased. By adding the mixing function by the scattering particles 9, the homogenization is improved, but the scattered light leaks without being confined in the inner surface of the optical mixer 6.

Although the total luminance is decreased to about 70%, at least the luminance distribution becomes substantially homogeneous when the density is 0.4%. It can be said that the length of the optical mixer 6 can be shortened to 7.5 times the length in a case where the scattering particles 9 are zero by filling with the scattering particles 9.

Next, the region characteristic of arranging the scattering particles 9 of the optical mixer 6 will be described with reference to FIG. 5. FIG. 5 illustrates the result of calculation of the total luminance and the luminance distribution by changing the region to which the scattering particles 9 are applied. In this calculation, as an example, the volume density of the scattering particles 9 is calculated as 0.84%. The vertical axis of FIG. 5 represents the total luminance and luminance distribution. The vertical axis is normalized by the total luminance in a case where the scattering particles 9 are zero. The white painting of the bar graph indicates the total luminance and the black painting indicates the luminance distribution.

In the horizontal axis, from the left side, a case where the scattering particles 9 are zero, a case where the scattering particles 9 are arranged at a length of 1 mm from the incident surface 7 side, a case where when scattering particles 9 are arranged at a length of 1 mm from the light emitting surface 8 side, and a case where the scattering particles 9 are arranged on the whole are illustrated.

In a case where the scattering particles 9 are zero, the total luminance is high, but the luminance distribution is zero. Similarly, in a case where the scattering particles 9 are arranged on the incident surface 7 side, the total luminance is high but the luminance distribution is low.

In a case where the scattering particles 9 are arranged on the light emitting surface 8 side, both the total luminance and the luminance distribution are sufficiently high. In a case where the scattering particles 9 are arranged on the whole, the luminance distribution is high but the total luminance is low.

Even if the scattering particles 9 are arranged on the incident surface 7 side where the irradiance distribution is low, the effect of improving the luminance distribution is small. On the contrary, if the irradiance distribution is increased on the side of the light emitting surface 8, the effect of improving the luminance distribution is large. In addition, the total luminance in a case where the scattering particles 9 are arranged on the light emitting surface 8 side is equivalent to that in a case where the scattering particles 9 are zero, and it can be said that there is no wasteful loss. From the above, it can be said that it is preferable that the scattering particles 9 are arranged on the light emitting surface 8 side rather than on the incident surface 7 side.

The optical mixer 6 first improves the irradiance distribution by mixing the incident light by inner surface reflection and later improves the luminance distribution by two mixing functions of inner surface reflection and scattering, so that can be said that the optical mixer has a function of efficiently homogenizing light.

Next, the size of the region where the scattering particles 9 are arranged on the light emitting surface 8 side will be described with reference to FIG. 6.

FIG. 6 illustrates the result of calculation of the region dependency on which the scattering particles 9 of the optical mixer 6 are arranged. The calculation is made under two conditions of a case where the external environment in contact with the side surface is air and a case where the side surface is a mirror structure with reflectance R=90%. In addition, as in the calculation of FIG. 5, as an example, the volume density of the scattering particles 9 is calculated as 0.84%.

In the graph on the left, the vertical axis represents the luminance distribution. In the graph on the right, the vertical axis represents the total luminance. Both of the horizontal axes represent the ratio of the length LP of the region filled with the scattering particles 9 to the length L of the optical mixer 6. Hereinafter, this ratio is referred to as a filling region ratio. For example, the filling region ratio of 25% denotes that, since the length L of the optical mixer 6 is 4 mm, the region with the length LP of 1 mm from the light emitting surface 8 side is filled with the scattering particles 9. A case where the external environment in contact with the side surface is set to air is illustrated by black painting, and a case where the side surface is set to have the mirror structure with the reflectance R=90% is illustrated by white painting.

As the filling region ratio is increased, the luminance distribution is improved. When the side surface is in contact with air, the total luminance is improved once and, after that, is decreased. In the case of a mirror structure, the total luminance is monotonously decreased.

The luminance distribution does not depend on the condition of the side surface, and the luminance distribution becomes homogeneous when the filling region ratio exceeds 17.5%. At this time, the total luminance was 1.02 in the case of air and 0.85 in the case of a mirror structure. That is, assuming that the side surface is set to air and the filling region ratio is set to be 17.5%, homogeneous light can be obtained with the best efficiency.

Even with a mirror structure, it can be understood that the total luminance of 0.85 higher than the total luminance of 0.7 (when the particle density is 0.4%) when the whole is filled with the scattering particles 9 is obtained.

In addition, the length L (about 4 mm) of the side surface of the optical mixer 6 is 2.83 times larger than the maximum diameter LM (about 1.41 mm) of the incident surface 7. In order to improve the irradiance, it is necessary to set the length L of the side surface to be longer than the maximum diameter LM of the incident surface 7. The maximum diameter LM may be set to be a size approximate to the size of the light source, but it is preferable to determine the density of the scattering particles 9 by setting the length of the side surface to a length smaller than three times the maximum diameter LM.

In other words, it can be said that the length L of the side surface can be allowed to be smaller than three times the maximum diameter LM.

As described above, by filling with the scattering particles in the optical mixer, it is possible to homogenize the light with a short distance. In addition, by arranging the scattering particles 9 only on the light emitting surface 8 side, light can be homogenized efficiently.

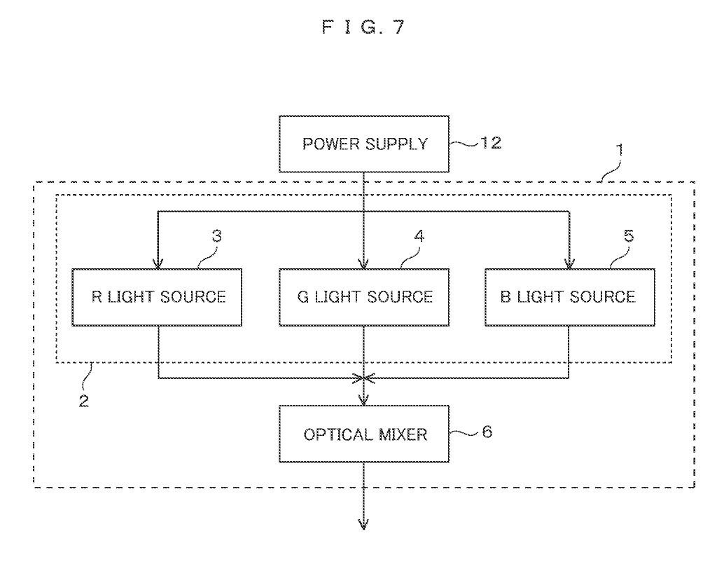

FIG. 7 is a system block diagram of the multi-wavelength homogeneous light source 1. The multi-wavelength homogeneous light source 1 is configured with a multi-wavelength light source substrate 2 provided with an R light source 3, a G light source 4, and a B light source 5 and an optical mixer 6. When the power supply 12 is supplied from the outside, the R light source 3, the G light source 4, and the B light source 5 can emit light with respective light amounts through electric wires (not illustrated) provided on the multi-wavelength light source substrate 2. The light that is homogenized through the optical mixer 6 is emitted as the emitted light. For example, when only the R light source 3 is allowed to emit light, homogeneous red light is emitted. When the R light source 3, the G light source 4, and the B light source 5 are allowed to individually emit light of respective predetermined light amounts, homogeneous white light is emitted.

As described above, the multi-wavelength homogeneous light source 1 can emit homogeneous light having a plurality of wavelengths and also has a function of adjusting color.

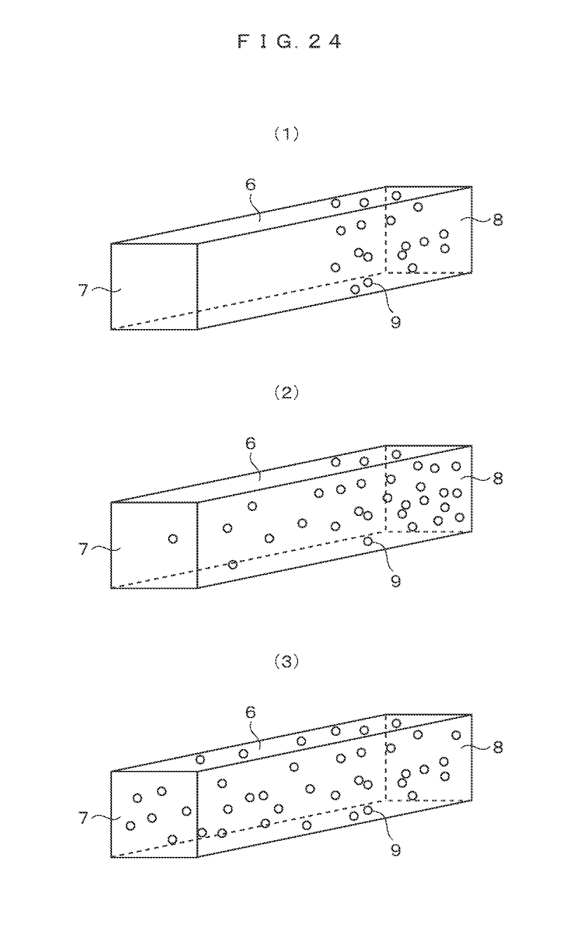

FIG. 24 illustrates an example of particle filling of the optical mixer 6. Although the optical mixer 6 where the transparent region and the scattering particles 9 are separated has been described in the example (1), the density may be changed as illustrated in FIG. 24(2), or the whole may be filled with the scattering particles 9 as illustrated in FIG. 24(3). In the case of changing the density as illustrated in FIG. 24(2), the efficiency can be increased by increasing the density on the light emitting surface 8 side.

### Second Embodiment

A second embodiment of the invention will be described with reference to the drawings.

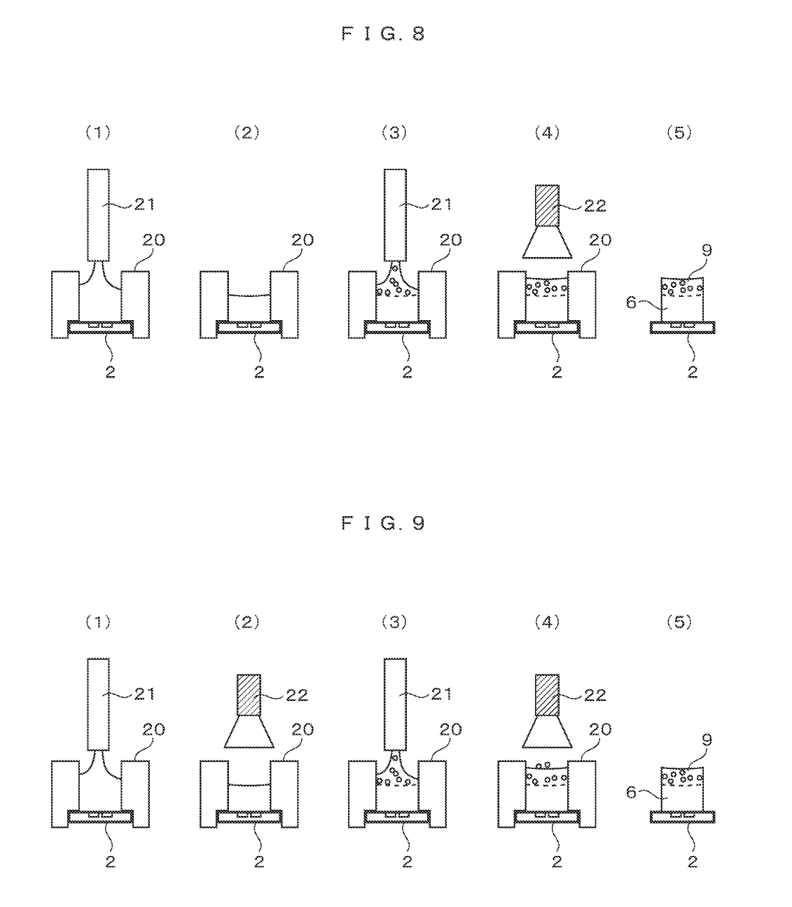

An example of a method of manufacturing the multi-wavelength homogeneous light source 1 will be described with reference to FIGS. 8 to 12.

FIG. 8 is a view describing a first example of the method of manufacturing the multi-wavelength homogeneous light source 1.

First, as illustrated in FIG. 8(1), the molding case 20 is set on the multi-wavelength light source substrate 2, and the transparent material of the optical mixer 6 is filled from above by the dispenser 21.

The multi-wavelength light source substrate 2 is assumed to be an LED provided with red, green, and blue LED chip light sources, and is realized by, for example, LTRB-R 8SF produced by OSRAM. In the LED, the LED chip light sources are arranged in a triangle shape as illustrated in FIG. 19 within a range of 1×1 mm or less.

The molding case 20 is a case of molding the outer shape of the optical mixer 6, which is the case coincident with the shape of the side surface of the optical mixer 6. In this case, any material such as metal, resin, glass or the like may be used, but it is preferable that the side surface thereof has a mirror surface with a surface roughness Ra<1.0 μm so as not to impair the function of inner surface reflection. In addition, in order to make it easier to detach the last molding case 20, the side surface may have an inclination (taper) in the vertical direction in the plane of the drawing.

The transparent material is assumed to be a photocurable resin and can be realized by Hitaroid 9501 produced by Hitachi Chemical Co., Ltd., for example, of a urethane acrylate based photocurable resin. The refractive index of this material is 1.49. Of course, other resin or thermoplastic resin may be used as long as the material is transparent.

After filling of the transparent material by using the dispenser 21, as illustrated in FIG. 8(3), the filling with the mixed material obtained by mixing the transparent material and the scattering particles 9 is performed by using the dispenser 21.

This transparent material is Hitaroid 9501, and scattering particles 9 are assumed to be transparent resin particles. For example, Techpolymer SSX-302ABE manufactured by Sekisui Plastics Co., Ltd. can be used. This is a fine particle made of a crosslinked polystyrene resin. The particles are monodisperse particles having a shape of a sphere and an average diameter of 2 μm, and approximately 95% of the particles have a difference within 0.5 μm from the average diameter. This refractive index is 1.58.

Of course, the scattering particles 9 may be air, a metal, an opaque resin, or the like. Even if the shape is not spherical, it does not matter. By using a transparent spherical shape of about 2 μm, the scattering direction can be controlled only in the forward direction, and thus, the loss of light is reduced, so that the effect of enhancing efficiency is obtained. It is preferable that the transparent materials filled in FIGS. 8(1) and 8(2) are the same, but different materials may be used as long as the refractive indexes are substantially the same. It should be noted that losses occur due to reflections at the boundary in a case where the refractive indices are largely different.

Since Techpolymer SSX-302A and Hitaroid 9501 have the same specific gravity, the scattering particles of the filled mixed material do not greatly move toward the transparent material side.

The filling may be performed so that air does not remain in the gap between the previously filled transparent material and the later filled mixed material.

In addition, it is preferable that care needs be taken not to enter an air layer having such a visible level as 0.1 mm in diameter during the filling. Since an air layer of which level is hard to visually recognize contribute to the scattering like the scattering particles 9, the air layer may remain inside.

Next, as illustrated in FIG. 8(4), illumination of UV light from the above is performed by the UV irradiator 22. In this case, it is preferable that the illumination is performed slowly over time with a reduced illumination amount of UV light so that only the upper side is not hardened. In a case where the molding case 20 is made transparent, the illumination of UV light can also be performed from the side surface side, so that it is possible to obtain an effect in a short time.

Finally, by detaching the molding case 20, the multi-wavelength homogeneous light source 1 is completed (5).

In addition, by greatly changing the specific gravity of the scattering particles 9 and the transparent resin, it is possible to fill with the mixed material only once and use a phenomenon of separating the scattering particles 9 and the transparent resin by gravity.

FIG. 9 is a view describing a second example of the method of manufacturing the multi-wavelength homogeneous light source 1.

In the second example of the method of manufacturing, after the filling of the transparent material (1), illumination of UV light is performed to harden the transparent material (2). After filling with the mixed material (3), illumination of UV light is performed again to harden the transparent material (4). Finally, by detaching the molding case 20, the multi-wavelength homogeneous light source 1 is completed (5).

In the second example of the method of manufacturing, for example, even in a case where the specific gravity of the scattering particles 9 is larger than that of the transparent material, it is possible to prevent the scattering particles 9 from permeating into the transparent material side due to gravity. That is, it is possible to obtain the effect of stabilizing the performance.

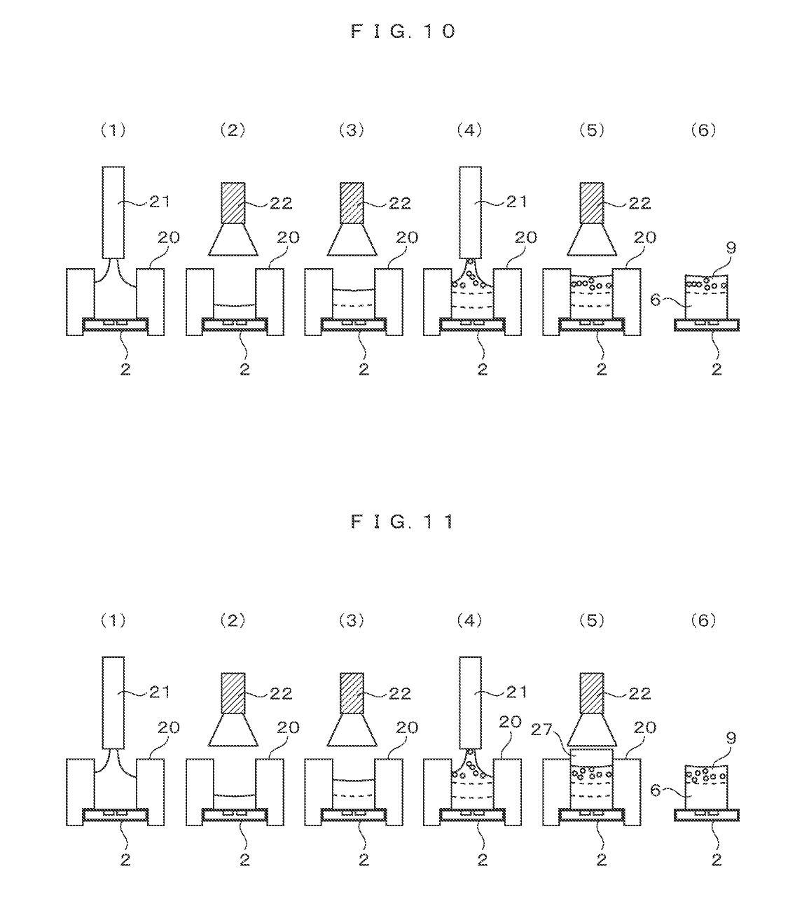

FIG. 10 is a view describing a third example of the method of manufacturing the multi-wavelength homogeneous light source 1.

In the third example of the method of manufacturing, after the filling of the transparent material (1), illumination of UV light is performed to harden the transparent material (2). Next, after the filling of the transparent material again, illumination of the UV light is performed to harden the transparent material (3). After filling with the mixed material (4), illumination of UV light is performed again to harden the transparent material (5). Finally, by detaching the shaping case 20, the multi-wavelength homogeneous light source 1 is completed (6).

In the third example of the method of manufacturing, it is assumed that the transparent material is laminated in plural times. By laminating in plural times, it is possible to obtain the effect of shortening the curing time by UV light having a large light amount so that the transparent material is not uncured.

FIG. 11 is a view describing a fourth example of the method of manufacturing the multi-wavelength homogeneous light source 1.

The difference between the third and fourth examples of the method of manufacturing is that, as illustrated in FIG. 11(5), the transparent plate 27 is placed above the mixed material before curing the mixed material, and then the curing with the UV light is performed over the transparent plate.

If the curing is performed over the transparent plate in this manner, since the light emitting surface 8 can be molded into a desired shape, it is possible to obtain the effect of being capable of manufacturing with an accurate angular distribution of the emitted light.

In addition, in the first to third examples of the manufacturing method, even if the step of cutting and polishing the light emitting surface 8 is finally selected, it is possible to manufacture with an accurate angular distribution of the emitted light.

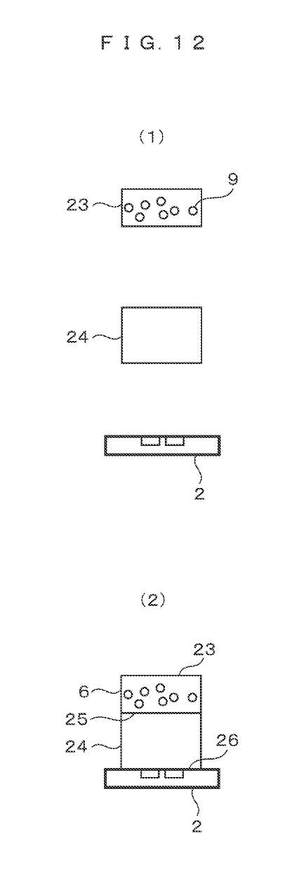

FIG. 12 is a view describing a fifth example of the method of manufacturing the multi-wavelength homogeneous light source 1.

As illustrated in FIG. 12(1), the particle portion 23 molded with the mixed material and the transparent portion 24 molded with the transparent material are prepared beforehand, and the boundary 25 between the particle portion 23 and the transparent portion 24 and boundary 26 between the particle portion 23 and the multi-wavelength light source substrate 2 may be joined with a transparent adhesive.

The fifth example of the method of manufacturing is effective in a case where a resin or glass of a high temperature thermoplastic material is used. In this case, if a transparent adhesive of which refractive index is close to that of the transparent material is used, loss of light can be reduced.

As described above, the multi-wavelength homogeneous light source 1 can be easily manufactured.

### Third Embodiment

A third embodiment of the invention will be described with reference to the drawings.

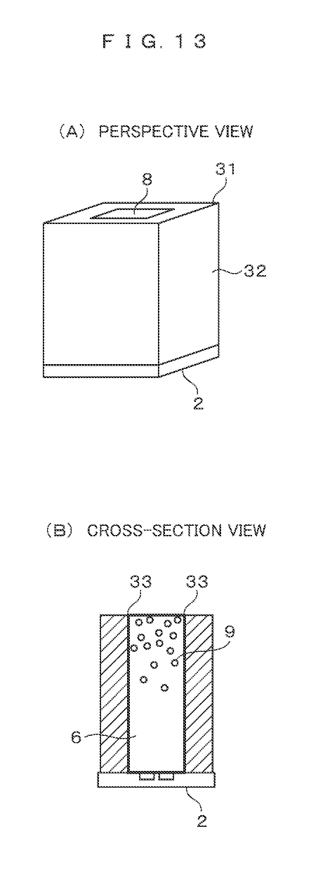

Modifications of the multi-wavelength homogeneous light source 1 and the multi-wavelength light source substrate 2 will be described with reference to FIGS. 13 to 20.

FIG. 13 is a schematic view illustrating a perspective view (A) and a cross-section view (B) of the multi-wavelength homogeneous light source 31.

As illustrated in FIG. 13, the multi-wavelength homogeneous light source 31 includes a multi-wavelength light source substrate 2, an optical mixer 6, and a casing 32.

This embodiment is different from the multi-wavelength homogeneous light source 1 in that the casing 32 is provided. The molding case 20 used for molding the optical mixer 6 is used directly as the casing 32.

It is assumed that the casing 32 is made of a non-transparent resin or metal. The boundary 33 with the optical mixer 6 has a function of reflecting light. The function of reflecting light can be realized by mirror-finishing a boundary 33 of the metal or resin casing 32, forming a reflective film, and forming a low reflectance film.

That is, the optical mixer 6 of the multi-wavelength homogeneous light source 31 has not a function of confining light by inner surface reflection as in the first embodiment but a function of confining light by the reflecting function at the boundary 33.

In a case where the reflectance is provided like the boundary 33, although the total luminance is slightly lowered as described in FIG. 6, there is an easy handling effect that it is easy to handle. In addition, since there is no step of detaching the molding case, there are merits in terms of cost.

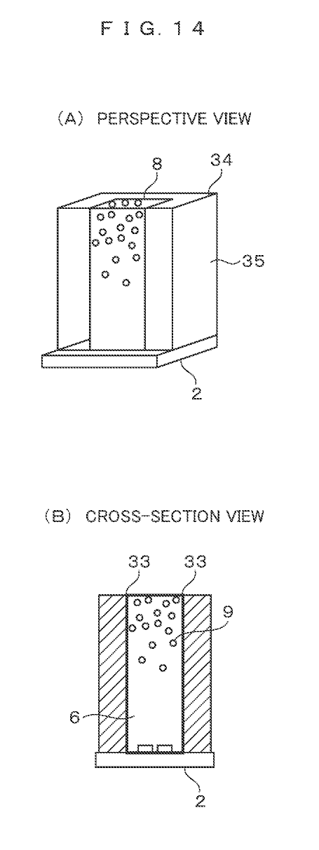

FIG. 14 is a schematic view illustrating a perspective view (A) and a cross-section view (B) of the multi-wavelength homogeneous light source 34.

The casing 35 of the multi-wavelength homogeneous light source 34 differs from the casing 32 of the multi-wavelength homogeneous light source 31 in that a portion of the side surface is eliminated. In this case, an auxiliary plate is required at the time of molding a portion of the side surface. By setting a portion as the air surface, it is possible to obtain an effect of improving the emitted luminance and an effect of easily irradiating the UV light. Similarly to the multi-wavelength homogeneous light source 31, it is possible to obtain a good handling effect.

Herein, although an example in which one surface is eliminated has been described, two surfaces may be eliminated.

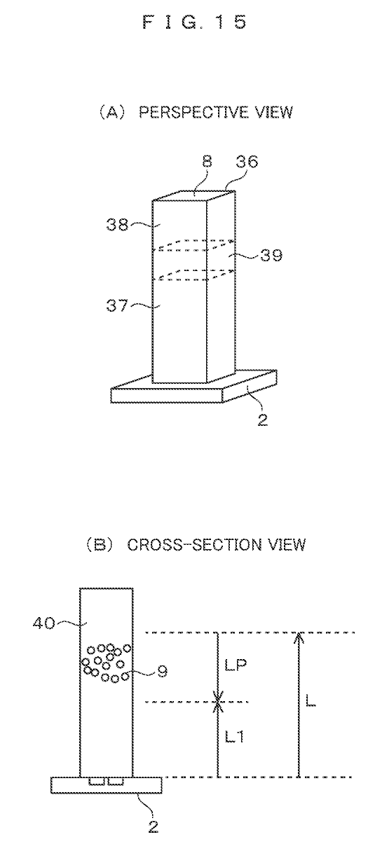

FIG. 15 is a schematic view illustrating a perspective view (A) and a cross-section view (B) of the multi-wavelength homogeneous light source 36.

The optical mixer 40 of the multi-wavelength homogeneous light source 36 is different from the optical mixer 6 of the multi-wavelength homogeneous light source 1 in that a transparent portion 38 is provided at the front end of the layer filled with the scattering particles 9.

The optical mixer 40 includes a transparent portion 37 which is in close contact with the multi-wavelength light source substrate 2, a particle portion 39 which is in close contact with the transparent portion 37, and a transparent portion 38 which is adjacent to the particle portion 39. The light passes through the transparent portion 37 and the particle portion 39 to be converted into homogeneous light similarly to the optical mixer 6. The homogenized light is emitted from the light emitting surface 8 while being confined in the transparent portion 38. For example, in a case where the multi-wavelength light source substrate 2 and the light emitting surface 8 are intended to be separated from each other due to structural restrictions, by adopting the configuration of the optical mixer 40, it is possible to obtain the effect of being capable of changing the light emitting surface of the homogenous light without loss of light. The transparent portion 38 may be further extended or bent.

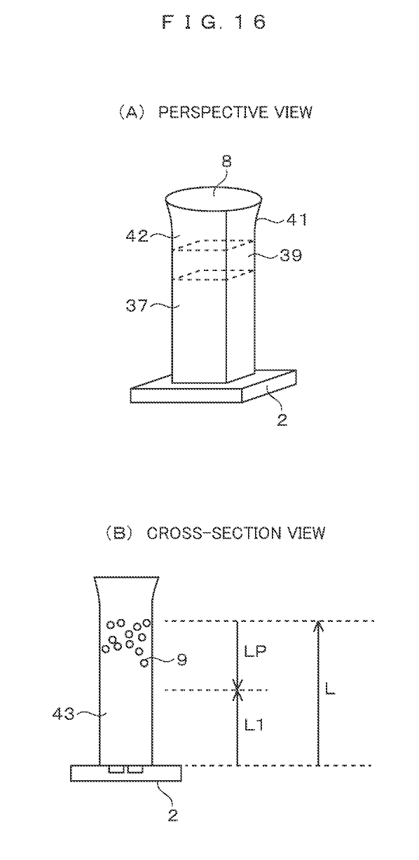

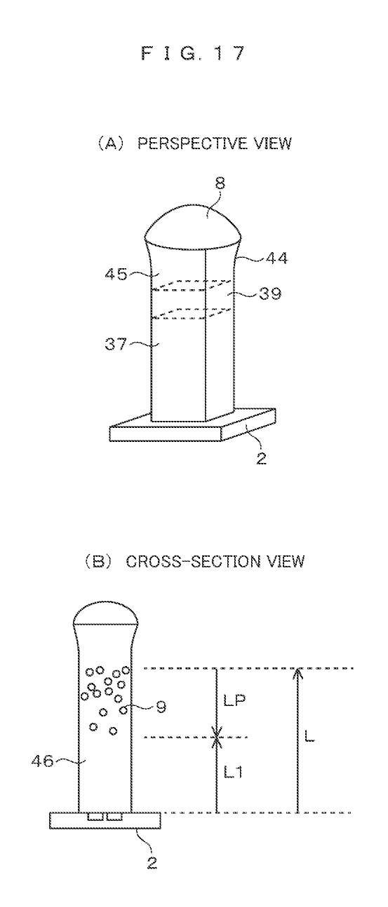

FIG. 16 is a schematic view illustrating a perspective view (A) and a cross-section view (B) of the multi-wavelength homogeneous light source 41.

The transparent portion 42 of the multi-wavelength homogeneous light source 41 is different from the transparent portion 38 of the multi-wavelength homogeneous light source 36 in that the shape of the light emitting surface 8 is circular.

For example, in the case of spotlight illumination or car headlights, it may be preferable that the region illuminated in a far distance is circular. In a case where the illumination of the light in a far distance is performed with the lens, the shape of the illuminated region becomes the shape of the light source. Since the light emitting surface 8 of the multi-wavelength homogeneous light source 41 is circular, by applying the light source as a light source of spotlight illumination or car headlight, the region illuminated in a far distance can be circular.

FIG. 17 is a schematic view illustrating a perspective view (A) and a cross-section view (B) of the multi-wavelength homogeneous light source 44.

The transparent portion 45 of the multi-wavelength homogeneous light source 44 is different from the transparent portion 42 of the multi-wavelength homogeneous light source 41 in that the shape of the light emitting surface 8 is formed in a convex shape.

As illustrated in the figure, when the light emitting surface 8 of the transparent portion 45 has a convex shape, the light distribution (angle characteristic) of the emitted light can be changed.

For example, in a case where light is intended to be emitted to the surroundings exceeding the full angle of 180 as the lighting application, it is preferable that the light emitting surface is configured to have a convex shape as illustrated in the figure. On the contrary, in a case where light is intended to be emitted only forward as projector applications, it is better to have a concave shape. The light distribution can be controlled according to the application.

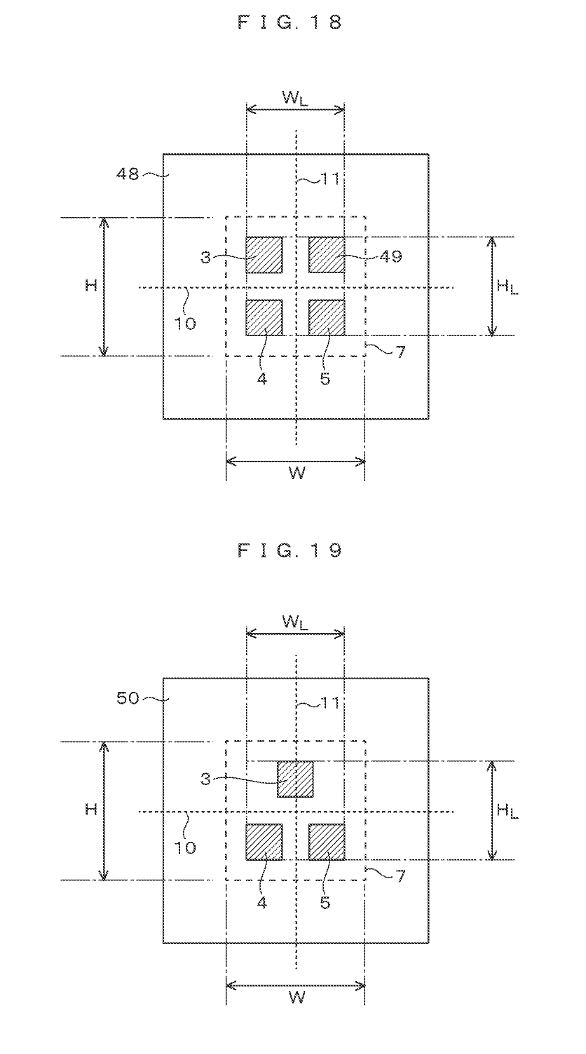

FIG. 18 is a schematic view illustrating the multi-wavelength light source substrate 48.

The multi-wavelength light source substrate 48 is different from the multi-wavelength light source substrate 2 in that a Y light source 49 that emits yellow light is provided.

The ranges of the WL and the height HL where the four light sources of the multi-wavelength light source substrate 48 are arranged are smaller than those of the H and the height W of the incident surface 7 of the optical mixer 6.

Since the multi-wavelength light source substrate 48 is provided with four light sources, the multi-wavelength homogeneous light source 1 can emit light beams which are homogenized with four wavelengths, respectively.

In addition, since the four light sources are provided within the range of the incident surface 7, the same optical efficiency as a case where the multi-wavelength light source substrate 2 is applied can be realized in the multi-wavelength light source substrate 48.

For example, in an image display device typified by a television, it is known that light beams having colors other than the three primary colors are used in order to expand the color reproduction range. By applying the multi-wavelength light source substrate 48, it is possible to realize a multi-wavelength homogeneous light source having a wide color reproduction range.

In addition, for example, if a near-infrared light source is applied to the Y light source 49, it is possible to realize a multi-wavelength homogeneous light source including a light source for infrared detection and a light source for a display device.

FIG. 19 is a schematic view illustrating the multi-wavelength light source substrate 50.

The multi-wavelength light source substrate 50 is different from the multi-wavelength light source substrate 2 in that the position of the R light source 3 is changed. If the ranges of the WL and the height HL where the three light sources are provided are smaller than those of the H and the height W of the incident surface 7 of the optical mixer 6, even if the position is shifted as illustrated in FIG. 19, there is no problem.

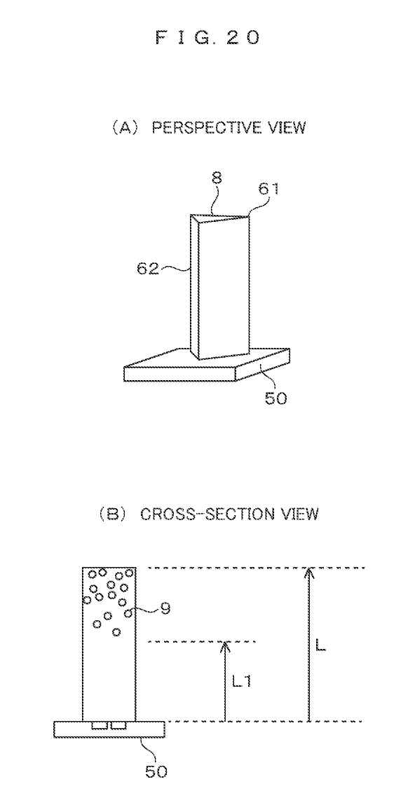

FIG. 20 is a schematic view illustrating a perspective view (A) and a cross-section view (B) of the multi-wavelength homogeneous light source 61.

As illustrated in FIG. 13, the multi-wavelength homogeneous light source 61 includes a multi-wavelength light source substrate 50 and an optical mixer 62.

The optical mixer 62 is different from the optical mixer 6 of the multi-wavelength homogeneous light source 1 in that the shape of the optical mixer 62 is a regular triangular prism. A combination of a light source arranged in a triangle like the multi-wavelength light source substrate 50 and an optical mixer 62 having a regular triangular prism is preferred.

As described above, the luminance is inversely proportional to the area. The optical mixer 62 is formed as a regular triangular prism in accordance with the arrangement of the multi-wavelength light source substrates 50 and is allowed to be smaller than the area of the light emitting surface 8 of the optical mixer 6. Therefore, the effect of improving the efficiency can be obtained for the multi-wavelength homogeneous light sources 61 in comparison with the multi-wavelength homogeneous light sources 1.

As described above, the example of the multi-wavelength homogeneous light source provided with a plurality of light sources having different wavelengths has been described. However, the invention is not limited thereto, for example, the multi-wavelength homogeneous light source may be configured as a homogeneous light source where the respective light sources are replaced with light sources having the same wavelength. Such a homogeneous light source of the same wavelength has an effect of being capable of emitting homogeneous light with high luminance.

### Fourth Embodiment

A fourth embodiment of the invention will be described with reference to the drawings.

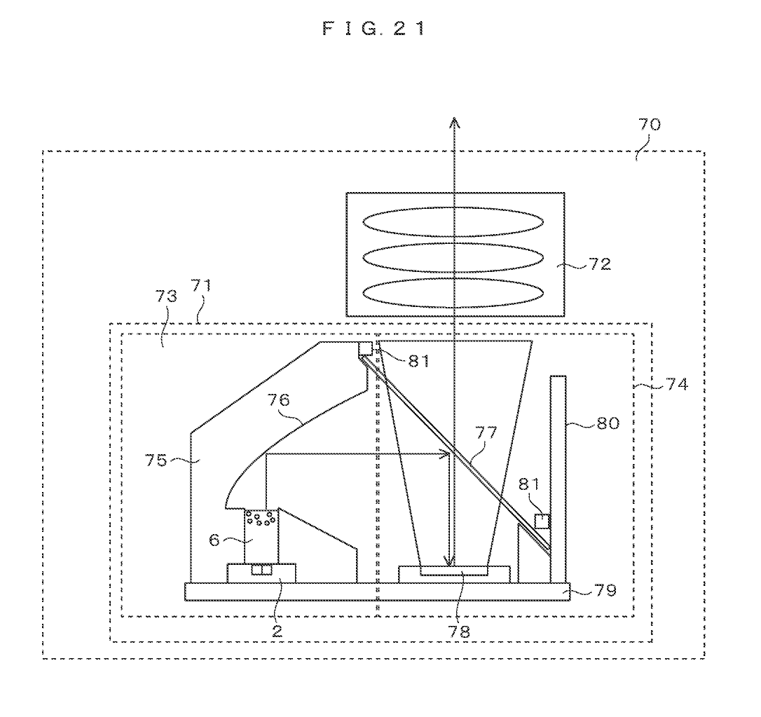

Application examples in which a multi-wavelength homogeneous light source is applied will be described with reference to FIGS. 21 to 24.

FIG. 21 is a schematic view illustrating an image projection device 70. The image projection device 70 is built in a projector, a head mounted display, or the like and has functions of generating an image and projecting the image on the screen.

The image projection device 70 includes an image generation device 71 having an illumination unit 73 and an image generation unit 74 and a projection unit 72.

In the illumination unit 73, a multi-wavelength light source substrate 2 and an optical mixer 6 are arranged in a casing 75. The light emitted from the multi-wavelength light source substrate 2 is homogenized by the optical mixer 6 and converted into substantially parallel light by the parabolic mirror 76 of the casing 75. The parabolic mirror 76 is a mirror having a parabolic shape where a focal point is located on the light emitting surface 8 of the optical mixer 6. It is generally known that the light emitted from the focal point becomes parallel as a parabola, and the parabolic mirror 76 uses this principle.

A micro display 78 and a polarization mirror 77 are provided in the image generation unit 74. Herein, the micro display 78 is assumed to be LCOS. The polarization mirror 77 is assumed to be a wire grid film that reflects light having predetermined polarization and transmits light having polarization orthogonal to the predetermined polarization. In addition, it is assumed that the casing 75 and the casing 80 have supporting mechanisms and the polarization mirror 77 is fixed by being suppressed with the casing cover 81.

The light that is allowed to be substantially parallel by the parabolic mirror 76 is reflected by the polarization mirror as the light having predetermined polarization and is illuminated on the micro display 78. With respect to the light with the pixel constituting the image on the micro display 78 being ON, the polarized light thereof is orthogonally reflected. On the contrary, the light with the pixel being Off is reflected as the polarized light without a change.

The light reflected from the micro display 78 is incident on the polarization mirror 77 again. At this time, only the light with the pixel being On is transmitted. That is, only the light having the information of the image signal is emitted from the image generation unit 74.

The light emitted from the image generation unit 74 is allowed to form an image on a predetermined screen by the projection unit. The projection unit is an optical lens for projecting the image generated by the micro display 78 onto a predetermined screen.

The multi-wavelength light source substrate 2 and the micro display 78 are mounted on a main board 79. Therefore, a simple configuration can be realized without using a flexible cable connecting the multi-wavelength light source substrate 2 and the micro display 78.

In an image projection device using LCOS, colorization of images is generally realized by a field sequential color (FSC) technology of emitting light beams from red, green, and blue light sources in a time division manner. In this embodiment, it is assumed that colorization is similarly formed using the FSC technique.

In a case where the FSC technology is used, the micro display must be illuminated with red, green, and blue light beams with homogeneous luminance as well as irradiance. In a case where the light to be illuminated is nonuniform, the image does not become uniform in color and brightness so that the image becomes nonuniform.

Since the optical mixer 6 is applied, the image can be allowed to be uniform in color and brightness in the image projection device 70.

Generally, the light source can be synthesized with a dichroic mirror to generate homogeneous light with high efficiency. However, three light sources are separately arranged, the light beams are collectively condensed by three separate lenses, and then two dichroic mirrors are used to combine the light beams. Therefore, in the related art, there are a total of eight components, so that it is difficult to reduce the size.

In the image projection device 70 of the present embodiment, the eight components in the related art can be realized by the two components of the optical mixer 6 and the multi-wavelength light source substrate. Therefore, it can be said that the size can be reduced with a small space.

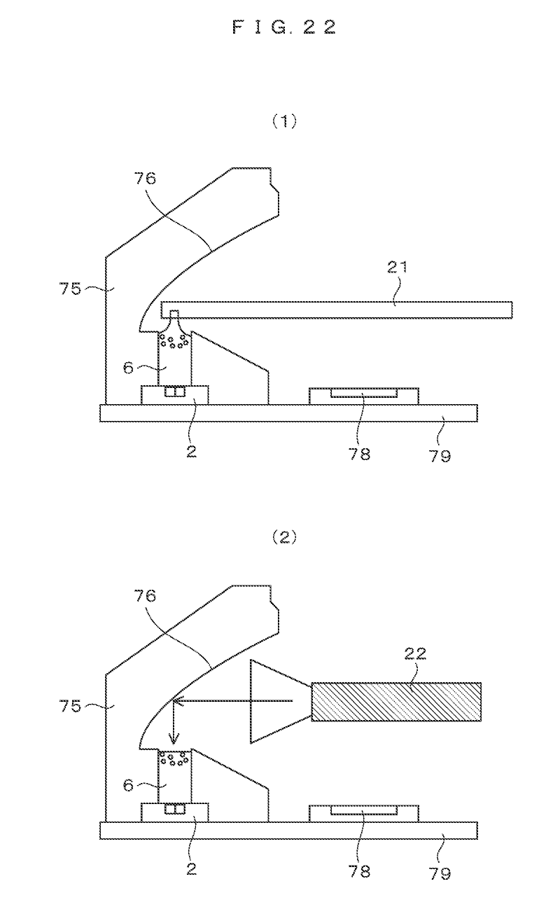

Next, an example of the manufacturing method the illumination unit will be described with reference to FIG. 22.

FIG. 22 is a view describing the example of the method of manufacturing the illumination unit 73.

The casing 75 of the illumination unit 73 is formed by integrally forming a parabolic mirror 76 and a support portion of a polarization mirror 77 in the casing 32 of the multi-wavelength homogeneous light source 31 of FIG. 13.

Therefore, the casing 75 is attached to the main board 79, and in this state, the filling of the transparent material and the mixed material from the dispenser 21 is performed (1). In addition, when irradiating the UV irradiator from the side, the light is reflected by the parabolic mirror 76, so that, illumination can be performed to cure the optical mixer 6 (2).

As described above, the boundary between the casing 75 and the optical mixer 6 has a function of reflecting light. The function of reflecting light can be realized by mirror polishing a metal, forming a reflective film, and forming a low reflectance film. Since the boundary of the casing 75 has a small space, it is easy to mold a high-reflectance metal, a white silicon resin, or the like with a mirror-polished mold.

As described above, the casing of a product to be applied may be used as a molding case for manufacturing the optical mixer. Since the number of manufacturing processes can be reduced, it is possible to expect effects in terms of costs.

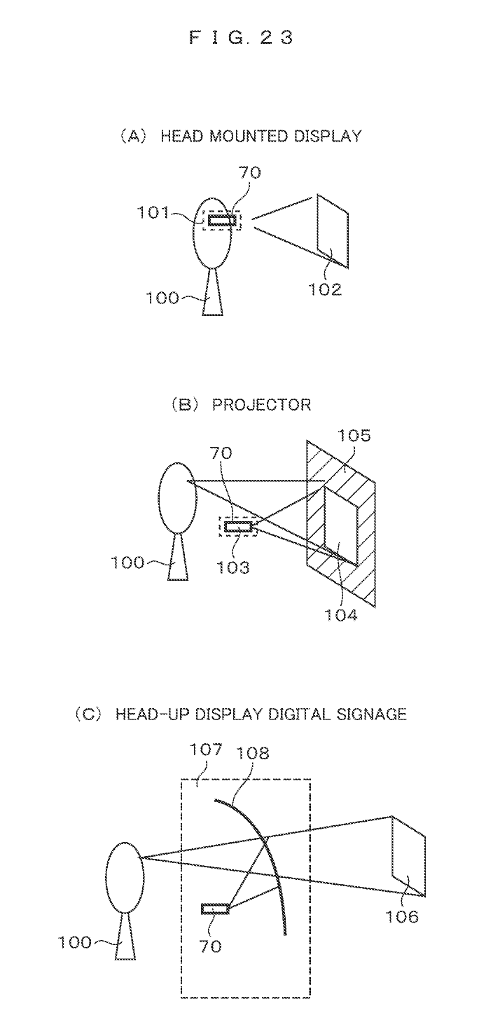

Next, an application example of the image projection device 70 will be described with reference to FIG. 23.

FIG. 23A is a view schematically illustrating a head mounted display 101, FIG. 23B is a view schematically illustrating a pocket projector 103, and FIG. 23C is a view schematically illustrating a head up display 107.

The head mounted display 101 is attached to the head of the user 100, and an image is projected from the image projection device 70 mounted inside the head mounted display 101 on the eyes of the user 100. The user can visually recognize the virtual image 102 which is an image floating in the air.

In the pocket projector 103, the image 104 is projected from the image projection device 70 onto the screen 105. The user 100 can visually recognize the image illustrated on the screen as a real image.

In the head-up display 107, an image is projected from the image projection device 70 mounted inside the head-up display on a virtual image generation unit 108. The virtual image generation unit has a function of a beam splitter transmitting a portion of light and reflecting the remaining light, has a curved surface structure, and also has a lens function of generating a virtual image by directly projecting an image on the eye of the user 100.

In the user 100, the user can visually recognize the virtual image 106 which is an image floating in the air. Such a head-up display is expected to be applied to an assist function for a driver of a car, a digital signage, and the like.

It is preferable that the image projection devices are compact and bright, and it is possible to realize a compact, bright image projection device by using the multi-wavelength homogeneous light source according to this embodiment.

In addition, it can also be applied to light sources such as spotlight illumination, car headlights and visible light communications.

As described above, the optical mixer 6 is formed in a transparent material and has a columnar shape (FIGS. 1, 20, and 24). In addition, the inside of the optical mixer 6 has a large number of the scattering particles 9 having the function of scattering light. In addition, the side surface of the optical mixer 6 has a function of reflecting light, the top surface (incident surface 7 or light emitting surface 8) and the bottom surface (incident surface 7 or light emitting surface 8) of the optical mixer have a function of transmitting light and a function of mixing the light incident from the top surface or the bottom surface with the reflecting function of the side surface and the scattering function of the scattering particles 9 and emitting mixed light from the top surface or the bottom surface. In addition, in the optical mixer 6, the length L of the side surface is larger than the outermost diameter LM of the top surface or the bottom surface.

In addition, the shape of the top surface or the bottom surface of the optical mixer 6 may be set to be a substantially regular triangular prism, a quadrangle, or a substantially regular hexagonal prism.

In addition, the density of the scattering particles 9 provided inside the optical mixer 6 is allowed to be different along the side surface.

In addition, on the top surface or the bottom surface side of the optical mixer 6, a region of a transparent material and a region where the transparent material and the scattering particles 9 are mixed are divided.

In addition, the scattering particles 9 of the optical mixer 6 are set to have a substantially transparent spherical shape, and to have a refractive index different from that of the transparent material of the optical mixer 6.

In addition, the ratio (L/LM) of the outermost diameter LM of the top surface or the bottom surface to the length L of the side surface of the optical mixer is smaller than 3.

In addition, the volume density of the scattering particles 9 arranged inside the optical mixer 6 is smaller than 1%.

In addition, the diameter of the scattering particles 9 may be in the range of 1 μm to 5 μm.

In addition, the multi-wavelength homogeneous light source includes a multi-wavelength light source substrate 2 having a plurality of light sources that emit light beams having different wavelengths and an optical mixer 6 that mixes the light beams. In the multi-wavelength homogeneous light source 1, the surface on which the plurality of light sources of the multi-wavelength light source substrate 2 are arranged and the top surface or the bottom surface of the optical mixer 6 are in close contact with each other.

In addition, a region (a region surrounded by the WL and the height HL in FIG. 2) where the plurality of light sources of the multi-wavelength light source substrate 2 are arranged is allowed to be smaller than the top surface or the bottom surface (the region surrounded by the W and the height H of the incident surface 7).

In addition, the density of the scattering particles 9 provided inside the optical mixer on the side far from the multi-wavelength light source substrate 2 along the side surface of the optical mixer 6 is high (for example, FIG. 24 (2)).

In addition, scattering particles 9 are provided only on the side far from the multi-wavelength light source substrate 2 along the side surface of the optical mixer 6 (for example, FIG. 24(1)).

In addition, the spaces between the plurality of light sources arranged on the multi-wavelength light source substrate 2 and the top surface or the bottom surface of the optical mixer are filled with a material having a refractive index substantially the same as that of the transparent material of the optical mixer.

### Fifth Embodiment

A fifth embodiment of the invention will be described with reference to the drawings.

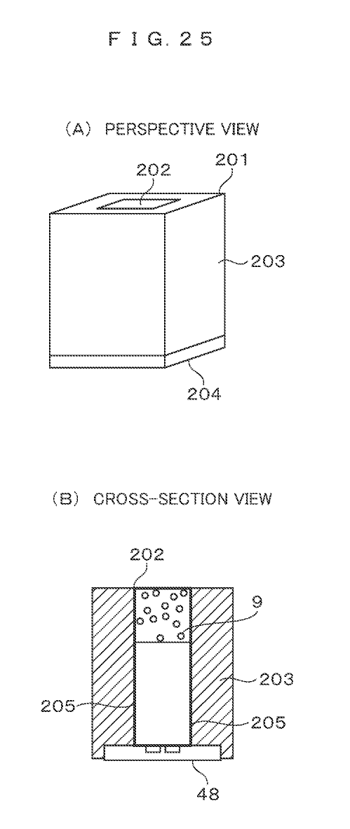

A modified example of the multi-wavelength homogeneous light source will be described with reference to FIG. 25.

FIG. 25 is a schematic view illustrating a perspective view (A) and a cross-section view (B) of the multi-wavelength homogeneous light source 1.

The multi-wavelength homogeneous light source 201 includes an optical mixer 202, a multi-wavelength light source substrate 48, and a casing 203.

The optical mixer 202 is filled with the scattering particles 9 at a uniform density and is the same as the particle portion 23 in FIG. 12.

As illustrated in FIG. 18, the multi-wavelength light source substrate 48 has four light sources and has a function of emitting light of four wavelengths.

The casing 203 is a mechanism for supporting the optical mixer 202 and the multi-wavelength light source substrate 48, and an inner wall 205 has a function of reflecting light.

For example, it can be realized with white resin or aluminum. Using MS-2002 produced by Toray Dow Corning Corporation, a high reflectance of about 98% can be realized.

The space between the multi-wavelength light source substrate 48 and the optical mixer 202 is an air layer. When the air layer is used in place of the transparent portion 24, since the incident angle is not converted by Snell's law, it is possible to allow the irradiance to be uniform in a distance shorter than the transparent portion 24 (in the vertical direction in the plane of the drawing). That is, it is possible to shorten the distance of the multi-wavelength homogeneous light sources 201 (in the vertical direction in the plane of the drawing).

### REFERENCE SIGNS LIST

1 multi-wavelength homogeneous light source
2 multi-wavelength light source substrate
3 R light source
4 G light source
5 B light source
6 optical mixer
7 incident surface
8 light emitting surface
9 scattering particles
10 central axis
11 central axis
12 power supply
20 molding case
21 dispenser
22 UV irradiator
23 particle portion
24 transparent portion
25 boundary
26 boundary
27 plate
31 multi-wavelength homogeneous light source
32 casing
33 boundary
34 multi-wavelength homogeneous light source
35 casing
36 multi-wavelength homogeneous light source
37 transparent portion
38 transparent portion
39 particle portion
40 optical mixer
41 multi-wavelength homogeneous light source
42 transparent portion
43 optical mixer
44 multi-wavelength homogeneous light source
45 transparent portion
46 optical mixer
48 multi-wavelength light source substrate
49 Y light source
50 multi-wavelength light source substrate
61 multi-wavelength homogeneous light source
62 optical mixer
70 image projection device
71 image generation device
72 projection unit
73 illumination unit
74 image generation unit
75 casing
76 parabolic mirror
77 polarization mirror
78 micro display
79 main board
80 casing
81 casing cover
100 user
101 head mounted display
103 pocket projector
107 head up display

1. An optical mixer for mixing light,
wherein the optical mixer has
a columnar shape made of a transparent material,
and contains a large number of scattering particles having a function of scattering light inside,
wherein a side surface of the optical mixer has a function of reflecting light,
wherein a top surface and a bottom surface of the optical mixer have a function of transmitting light,
wherein a length of the side surface of the optical mixer is larger than an outermost diameter of the top surface or the bottom surface,
wherein light incident from the top surface or the bottom surface is mixed by the reflecting function of the side surface and the scattering function of the scattering particles, and mixed light is emitted from the top surface or the bottom surface.

2. The optical mixer according to claim 1, wherein a shape of the top surface or the bottom surface of the optical mixer is formed as a substantially regular triangular prism, a quadrangle, or a substantially regular hexagonal prism.

3. The optical mixer according to claim 2, wherein a density of the scattering particles provided inside the optical mixer is set to be different along the side surface.

4. The optical mixer according to claim 3, wherein the top surface side or the bottom surface side of the optical mixer is divided into a region of the transparent material and a region where the transparent material and the scattering particles are mixed.

5. The optical mixer according to claim 4, wherein the scattering particles are set to have a substantially transparent spherical shape and to have a refractive index different from that of the transparent material of the optical mixer.

6. The optical mixer according to claim 5, wherein a ratio (L/LM) of the outermost diameter LM of the top surface or the bottom surface to the length L of the side surface of the optical mixer is smaller than 3.

7. The optical mixer according to claim 6, wherein a volume density of the scattering particles arranged inside the optical mixer is less than 1%.

8. The optical mixer according to claim 7, wherein a diameter of the scattering particles is set to be in a range of 1 μm to 5 μm.

9. A multi-wavelength homogeneous light source for emitting homogeneous light having a plurality of wavelengths, comprising:
a multi-wavelength light source substrate having a plurality of light sources emitting light having different wavelengths; and
an optical mixer mixing the light,
wherein the optical mixer has a columnar shape made of a transparent material, and a length of a side surface is larger than an outermost diameter of a top surface or a bottom surface of the columnar shape,
wherein a large number of scattering particles having a function of scattering light are contained inside the optical mixer,
wherein the side surface of the optical mixer has a function of reflecting light,
wherein the top surface and the bottom surface of the optical mixer have a function of transmitting light,
wherein a function of mixing light incident from the top surface or the bottom surface by the reflecting function of the side surface and the scattering function of the scattering particles is provided, and
wherein, in the multi-wavelength homogeneous light source, a surface where the plurality of light sources of the multi-wavelength light source substrate are arranged and the top surface or the bottom surface of the optical mixer are in close contact with each other.

10. The multi-wavelength homogeneous light source according to claim 9, wherein a region where the plurality of light sources of the multi-wavelength light source substrate are arranged is set to be smaller than the top surface or the bottom surface.

11. The multi-wavelength homogeneous light source according to claim 10, wherein a shape of the top surface or the bottom surface of the optical mixer is formed as substantially a regular triangular prism, a quadrangle, or a substantially regular hexagonal prism.

12. The multi-wavelength homogeneous light source according to claim 11, wherein a density of the scattering particles provided inside the optical mixer on a side far from the multi-wavelength light source substrate along the side surface of the optical mixer is high.

13. The multi-wavelength homogeneous light source according to claim 12, wherein the scattering particles are provided only on the side far from the multi-wavelength light source substrate along the side surface of the optical mixer.

14. The multi-wavelength homogeneous light source according to claim 13, wherein the scattering particles are set to have a substantially transparent spherical shape and to have a refractive index different from that of the transparent material of the optical mixer.

15. The multi-wavelength homogeneous light source according to claim 14, wherein a ratio (LS/LIO) of the outermost diameter LIO of the top surface or the bottom surface to the length LS of the side surface of the optical mixer is smaller than 3.

16. The multi-wavelength homogeneous light source according to claim 15, wherein a volume density of the scattering particles arranged inside the optical mixer is less than 1%.

17. The multi-wavelength homogeneous light source according to claim 16, wherein a diameter of the scattering particles is set to be in a range of 1 μm to 5 μm.

18. The multi-wavelength homogeneous light source according to claim 17, wherein a space between the plurality of light sources arranged on the multi-wavelength light source substrate and the top surface or the bottom surface of the optical mixer is filled with a material having a refractive index substantially the same as that of the transparent material of the optical mixer.
